(19) United States
(12) Patent Application Publication
(10) Pub. No.: US 2020/0132920 A1
(43) Pub. Date: Apr. 30, 2020

(54) BACKPLANE, BACKLIGHT MODULE, AND LIQUID CRYSTAL DISPLAY DEVICE

(71) Applicant: HUIZHOU CHINA STAR OPTOELECTRONICS TECHNOLOGY CO., LTD., Guangdong (CN)

(72) Inventor: Jiaxin LI, Huizhou Guangdong (CN)

(21) Appl. No.: 15/752,169

(22) PCT Filed: Jan. 24, 2018
(86) PCT No.: PCT/CN2018/073986

§ 371 Date: Feb. 12, 2018

(30) Foreign Application Priority Data
Jan. 4, 2018 (CN) 201810007409.4

(51) Int. Cl. F21V 8/00; G02F 1/1333

(52) U.S. Cl. CPC G02B 6/0085; G02B 6/009; G02F 2001/133317; G02F 2001/133314; G02F 1/133308

(57) ABSTRACT

The disclosure provides a backplane, including a bracket including a bottom of the bracket and a sidewall of the bracket disposed at a side of the bottom, and the bottom has an opening, an end of the sidewall away from the bottom is configured to connect to a middle frame; a substrate, detachably sealing the opening, and the substrate facing a surface of the bracket is configured to mount a light emitting component, and a surface of the substrate away from the bracket is configured to mount a heat dissipating component. The disclosure also provides a backlight module including the backplane and a LCD device including the backlight module. The LCD can solve the heat dissipation problem and reduce the cost when the same type LCD panel adopts different backlight brightness or needs to be suitable for different temperature conditions by replacing the substrate without changing the other structures.

### RELATED APPLICATIONS

The present application is a National Phase of International Application Number PCT/CN2018/073986, filed Jan. 24, 2018, and claims the priority of China Application No. 201810007409.4, filed Jan. 4, 2018.

### FIELD OF THE DISCLOSURE

The disclosure relates to the field of display technology, in particular to a backplane, a backlight module, and a liquid crystal display device.

### BACKGROUND

With the evolution of optoelectronics and semiconductor technology, it has also driven the flourishing development of flat panel display, in many flat panel displays, the liquid crystal display device (LCD) has become the mainstream market and is more and more widely used due to its advantageous characteristics such as high space utilization, low power consumption, no radiation, and low electromagnetic interference, and the liquid crystal display device also has a huge market demand in the field of outdoor display.

Due to the socio-economic development, the demand for outdoor advertisements in various industries is becoming more and more exuberant, and the form of outdoor advertisements is gradually moving from static posters to dynamic short videos. At present, the mainstream of the outdoor display technology is mainly the light-emitting diose (LED) display screen but its disadvantages are also obvious, too bulky and too low resolution limits its application in specific high-end field. As a result, LCD display screens are beginning to be applied to outdoor displays. However, the outdoor ambient temperature is sometimes high, the LCD screen may be damaged when the temperature is too high. Generally, the outdoor display uses a backlight module with a heat dissipation component on the backplane; however, based on the different brightness requirements, the dissipation requirements are different. However, since the outdoor displays are generally manufactured in custom, the demand for each model is not large, and the cost is higher if the backplane with heat dissipating component is manufactured in custom for each type of liquid crystal display. Therefore, how to solve the heat dissipation problem of the liquid crystal display effectively and at low cost is a problem to be solved urgently.

### SUMMARY

In order to solve the above problems in the prior art, the disclosure provides a backplane, a backlight module, and a liquid crystal display device that can solve the heat dissipation problem of the liquid crystal display effectively and at low cost.

According to an aspect of the disclosure, there is provided a backplane, including:

a bracket, including a bottom of the bracket and a sidewall of the bracket disposed at a side of the bottom of the bracket, and the bottom of the bracket including an opening, an end of the sidewall of the bracket away from the bottom of the bracket being configured to connect to a middle frame; and

a substrate, detachably sealing the opening, and a surface of the substrate facing the bracket being configured to mount a light emitting component, and a surface of the substrate away from the bracket being configured to mount a heat dissipating component.

The sidewall of the bracket includes a first portion formed by folding outwardly from a side of the bottom of the bracket, a second portion disposed at an end of the first portion away from the bottom of the bracket and parallel to the bottom of the bracket, and a third portion disposed at an end of the second portion away from the first portion and perpendicular to the second portion.

An outer surface of the third portion includes a connecting portion configured to connect to the middle frame.

The connecting portion is a convex structure and/or a buckle.

The substrate detachably seals the opening by screwing and/or welding.

The substrate is made of aluminum or copper.

According to another aspect of the disclosure, there is further provided a backlight module, including the backplane, a light emitting component disposed on a surface of the substrate facing the bracket, and a light guide plate, an optical film, a middle frame, and a front frame sequentially arranged on the sidewall of the bracket.

The middle frame includes a bottom of the middle frame and a sidewall of the middle frame disposed on a side of the bottom of the middle frame, and the sidewall of the middle frame is connected to the sidewall of the bracket.

The backlight module further includes a heat dissipating component disposed on a surface of the substrate away from the bracket.

The middle frame is made of a plastic material.

According to further another aspect of the disclosure, there is provided a liquid crystal display device including a liquid crystal panel and a backlight module. The liquid crystal panel is disposed opposite to the backlight module, the backlight module provides a display light source to the liquid crystal panel so as to make the liquid crystal panel display an image, and the backlight module is the above-mentioned backlight module.

Additional aspects and/or advantages of the disclosure will be set forth in part in the description which follows, and in part will be obvious from the description, or may be learned by practice of the disclosure.

### BRIEF DESCRIPTION OF THE DRAWINGS

The forgoing and/or other objects and advantages of the disclosure will become more fully apparent from the following detailed description of the embodiment, the appended claims and the accompanying drawings in which:

FIG. 1 shows a schematic structural view of a backplane;

FIG. 2 shows a schematic structural view of a backplane mounted with a light emitting component and a heat dissipating component;

FIG. 3 shows a schematic structural view of a substrate mounted with a light emitting component and a heat dissipating component;

FIG. 4 shows a schematic structural view of a backlight module; and

FIG. 5 shows a schematic structural view of a liquid crystal display device.

### DETAILED DESCRIPTION OF PREFERRED EMBODIMENTS

Hereinafter, embodiments of the disclosure will be described in detail with reference to the accompanying drawings. In the drawings, the main elements related to the inventive concept are clearly and concisely shown, the shape of layers or regions may be exaggerated, and the minor elements may be omitted to avoid obscuring the description. The same reference numerals generally indicate the same elements throughout the specification. However, the disclosure is not limited to the following examples. The features, elements, or structures referred to in the various embodiments or the corresponding method descriptions may be applied to other embodiments alone or in combination.

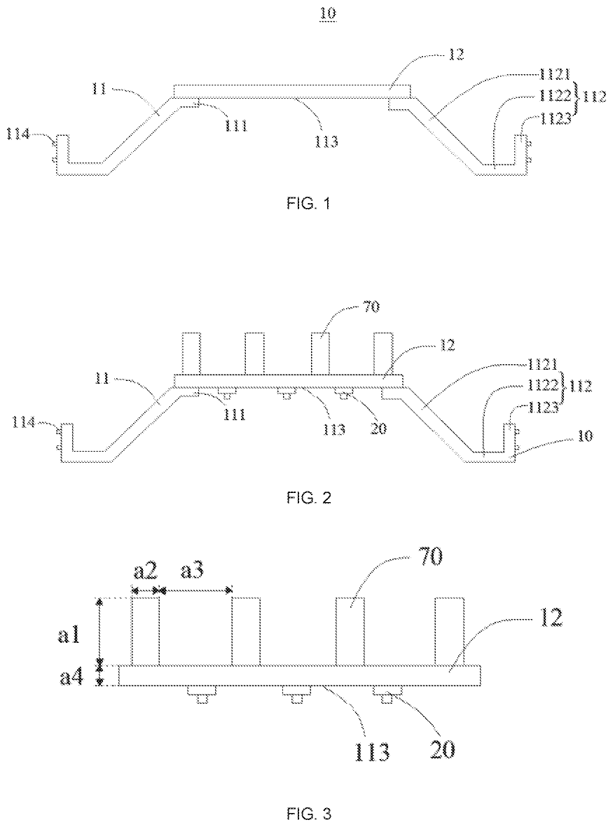

FIG. 1 shows a schematic structural view of a backplane. FIG. 2 shows a schematic structural view of a backplane mounted with a light emitting component and a heat dissipating component. FIG. 3 shows a schematic structural view of a substrate mounted with a light emitting component and a heat dissipating component.

As shown in FIGS. 1, 2, and 3, the backplane includes a bracket 11 and a substrate 12. The bracket 11 and the substrate 12 are detachably fixed together. However, it is to be understood that the disclosure is not limited thereto, and the backplane according to the embodiment of the disclosure may further include other necessary components.

Specifically, the bracket 11 includes a bottom 111 of the bracket and a sidewall 112 of the bracket disposed on a side of the bottom 111 of the bracket. The bottom 111 of the bracket has an opening 113. The bottom 111 of the bracket is configured to connect with the substrate 12. The opening 113 of the bottom 111 of the bracket should accommodate the light-emitting component mounted on the substrate 12. An end of the sidewall of the bracket away from the bottom of the bracket is configured to connect to a middle frame.

According to an embodiment of the disclosure, the sidewall 112 of the bracket includes a first portion 1121 formed by folding outwardly from a side of the bottom 111 of the bracket, a second portion 1122 disposed at an end of the first portion 1121 away from the bottom of the bracket and parallel to the bottom 111 of the bracket, and a third portion 1123 disposed at an end of the second portion 1122 away from the first portion and perpendicular to the second portion 1122. The first portion 1121 is formed by folding outwardly from a side of the bottom 111 of the bracket; therefore, the first portion 1121 forms an internal cavity around the bottom 111 of the bracket, the internal cavity is a space that can accommodate the light-emitting components. The second portion 1122 is parallel to the bottom 111 of the bracket, and the second portion 1122 is configured to support the components thereon such as a light guide plate and an optical film. The third portion 1123 is perpendicular to the second portion 1122 and corresponds to the most lateral side of the bracket 11 and is mainly configured to connect to the middle frame.

As an example, the connecting portion 114 configured to connect to the middle frame is disposed on the outer surface of the third portion 1123. According to a preferred embodiment of the disclosure, the connecting portion 114 may be a convex structure and/or a buckle. It can be understood that the middle frame and a surface opposite to the third portion 1123 also includes a connecting portion, the connecting portion corresponding to the connecting portion 114 of the third portion 1123 can be a corresponding concave structures and/or a buckle, However, the disclosure is not limited thereto, and other suitable connection structures may also be applied to the structural design of the connecting portion 114.

The substrate 12 detachably seals the opening 113. Referring to FIG, 2, the substrate 12 faces the surface of the bracket 11 configured to mount the light emitting component. A surface of the substrate 12 away from the bracket 11 is configured to mount a heat dissipating component. The light emitting component generates a lot of heat when working, that is to say, one surface of the substrate 11 is mounted with a heat source, the other surface of the substrate 11 is mounted with the heat dissipating component, so the main components that determine the heat dissipation capability of the liquid crystal display device are the substrate and the heat dissipating component disposed on the substrate. The heat dissipating component 70 is usually composed of a dissipating fin and a fan. Referring to FIG. 3, the thickness al , the height a2, and the spacing a3 of the heat dissipating fins affect the heat dissipation capability. In addition, the thickness a4 of the substrate also affects one aspect of the heat dissipation capability. And the substrate 12 detachably seals the opening 113, that is, under different dissipating conditions, only the substrate 12 and the dissipating structure suitable of the dissipating condition needs to be designed; by replacing the substrate 12 suitable for the heat dissipation condition correspondingly,

it can be applied to the different dissipating environment. In addition, the module design of the substrate 12 is much simpler than the module design of the backplane and the required cost is relatively low. Therefore, the design of the substrate 12 can effectively solve the problem of heat dissipation in different environments and has a lower cost.

According to one embodiment of the disclosure, the substrate 12 is detachably fixed to the bottom 111 of the bracket by screws. In addition, the substrate 12 may also be detachably fixed to the bottom 111 of the bracket by welding. Of course, the disclosure is not limited thereto, and the substrate 12 can also be fixed with the bottom 111 of the bracket in other suitable detachable manner.

In addition, since the substrate 12 is configured to conduct the heat generated by the light-emitting component to the heat dissipating component, according to one embodiment of the disclosure, the substrate 12 is made of metal having better heat transfer property. As one of the embodiments, the substrate 12 is made of aluminum. As one of the embodiments, the substrate 12 may also be made of copper. However, the disclosure is not limited thereto, and the substrate 12 can also be made of other materials having better heat transfer performance.

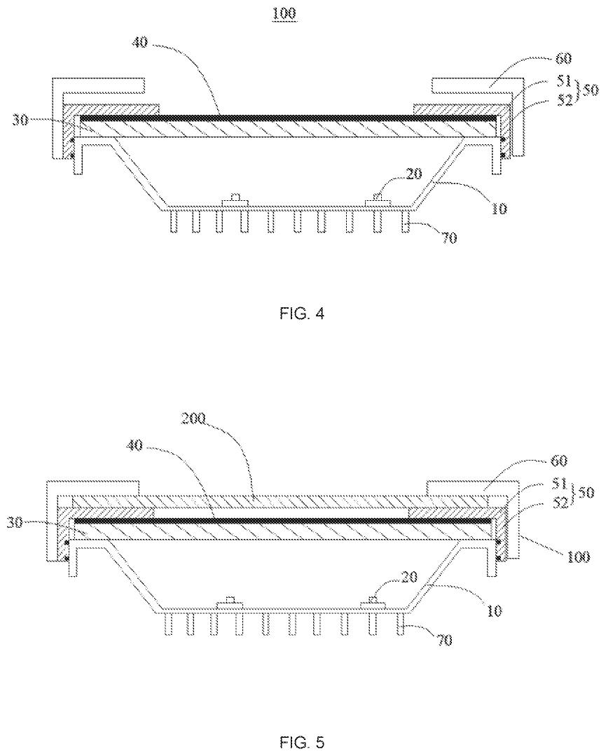

FIG. 4 shows a schematic structural view of a backlight module.

As shown in FIG. 4, the backlight module includes the backplane 10, a light emitting component 20, a heat dissipating component 70, a light guide plate 30, an optical module 40, a middle frame 50, and a front frame 60. However, it is understandable that the disclosure is not limited thereto, and the backlight module according to the embodiment of the disclosure may further include other necessary components.

Specifically, the backplane 10 is the backplane 10 where the substrate 12 can be detachably replaced. A surface of the substrate 10 facing the bracket 11 includes a light emitting component 20, the light emitting component 20 is configured to provide a light source needed by the backlight module, and simultaneously, the light emitting component 20 generates a lot of heat during working. As one of the embodiments, a surface of the substrate 12 away from the bracket 11 includes a heat dissipating component 70, the heat dissipating component 70 is configured to dissipate the heat conducted from the substrate 12; it can be understood that the structure of the heat dissipating component 70 is matched with the structure of the substrate 12 to adapt the use of the backlight module with different temperature requirements. The light guide plate 30, the optical film 40, the middle frame 50, and the front frame 60 are sequentially disposed on the sidewall 112 of the bracket.

According to one embodiment of the disclosure, the middle frame 50 includes a bottom 51 of the middle frame and a sidewall 52 of the middle frame disposed at a side of the bottom 51 of the middle frame. The sidewall 52 of the middle frame is connected to the sidewall 112 of the bracket. As one of the embodiments, the sidewall 52 of the middle frame is connected with the third portion 1123. As one embodiment, a connecting portion corresponding to the connecting portion 114 of the third portion 1123 is disposed on a surface of the sidewall 52 of the middle frame facing to an outer surface of the third portion 1123. The connecting portion may be a corresponding concave portion and/or a buckle structure, which is not limited in the disclosure. As one of the embodiments, the middle frame 50 is made of a plastic material, but the disclosure is not limited thereto, and the middle frame may also be made of other suitable materials.

The backlight module according to the embodiment of the disclosure can be applied to a variety of temperature conditions simply by replacing the substrate 10 and the heat dissipating component 70 matching the temperature conditions and can effectively solve the problem that the backlight module is suitable for different temperature conditions and greatly save the cost.

FIG. 5 shows a schematic structural view of a liquid crystal display device,

As shown in FIG. 5, the liquid crystal display device according to the embodiment of the disclosure includes a liquid crystal panel 200 and the backlight module 100. However, it is to be understood that the disclosure is not limited thereto, and the liquid crystal display device according to the embodiment of the disclosure may further include other necessary components,

Specifically, the liquid crystal panel 200 is disposed opposite to the backlight module 100, and the backlight module 100 provides a display light source to the liquid crystal panel 200 to make the liquid crystal panel 200 display an image.

The liquid crystal display device of the disclosure can be applied to various temperature conditions simply by replacing the substrate 12 and the heat dissipating component 70 that match with the temperature condition, effectively solving the problem that the liquid crystal display device is suitable for different temperature conditions and greatly saving the cost.

The above embodiments of the disclosure are merely exemplary, and the disclosure is not limited thereto. It should be understood by those skilled in the art that various changes may be made to these embodiments without departing from the principles of the disclosure, the scope of which is defined in the claims and their equivalents.

What is claimed is:

1. A backplane, comprising:
a bracket, comprising a bottom of the bracket and a sidewall of the bracket disposed at a side of the bottom of the bracket, wherein the bottom of the bracket has an opening, and an end of the sidewall of the bracket away from the bottom of the bracket is configured to connect to a middle frame; and
a substrate, detachably sealing the opening, wherein a surface of the substrate facing the bracket is configured to mount a light emitting component, and a surface of the substrate away from the bracket is configured to mount a heat dissipating component.

2. The backplane according to claim 1, wherein the sidewall of the bracket comprises a first portion formed by folding outwardly from a side of the bottom of the bracket, a second portion disposed at an end of the first portion away from the bottom of the bracket and parallel to the bottom of the bracket, and a third portion disposed at an end of the second portion away from the first portion and perpendicular to the second portion.

3. The backplane according to claim 2, wherein an outer surface of the third portion comprises a connecting portion configured to connect to the middle frame.

4. The backplane according to claim 3, wherein the connecting portion is a convex structure and/or a buckle.

5. The backplane according to claim 1, wherein the substrate detachably seals the opening by screwing and/or welding.

6. The backplane according to claim 1, wherein the substrate is made of aluminum or copper.

7. A backlight module, comprising:
the backplane according to claim 1;
a light emitting component disposed on a surface of the substrate facing the bracket; and
a light guide plate, an optical film, a middle frame, and a front frame sequentially arranged on the sidewall of the bracket;
wherein the middle frame includes a bottom of the middle frame and a sidewall of the middle frame disposed on a side of the bottom of the middle frame, and the sidewall of the middle frame is connected to the sidewall of the bracket.

8. The display module according to claim 7, wherein the backlight module further comprises a heat dissipating component disposed on a surface of the substrate away from the bracket.

9. The display module according to claim 7, wherein the middle frame is made of a plastic material.

10. The display module according to claim 7, wherein the sidewall of the bracket comprises a first portion formed by folding outwardly from a side of the bottom of the bracket, a second portion disposed at an end of the first portion away from the bottom of the bracket and parallel to the bottom of the bracket, and a third portion disposed at an end of the second portion away from the first portion and perpendicular to the second portion.

11. The display module according to claim 10, wherein an outer surface of the third portion comprises a connecting portion configured to connect to the middle frame.

12. The display module according to claim 11, wherein the connecting portion is a convex structure and/or a buckle.

13. The display module according to claim 7, wherein the substrate detachably seals the opening by screwing and/or welding.

14. The display module according to claim 7, wherein the substrate is made of aluminum or copper.

15. A liquid crystal display device, comprising:
a liquid crystal panel; and
a backlight module;
wherein the liquid crystal panel is disposed opposite to the backlight module, the backlight module provides a display light source to the liquid crystal panel so as to make the liquid crystal panel display an image; wherein the backlight module is the backlight module according to claim 7.
